(19) United States
(12) Patent Application Publication
(10) Pub. No.: US 2015/0317925 A1
(43) Pub. Date: Nov. 5, 2015

(54) Advertisement campaign system using escalators and moving walkways.

(71) Applicant: The Elleven s.r.o., Prague (CZ)

(72) Inventors: Krishan Kumar Advaney, Prague (CZ); Martina Advaney, Prague (CZ)

(21) Appl. No.: 14/268,585

(22) Filed: May 2, 2014

(51) Int. Cl. G09F 23/00; B66B 31/00; G06Q 90/00; B66B 29/00

(52) U.S. Cl. CPC G09F 23/00; B66B 29/00; B66B 31/00; G06Q 90/00

(57) ABSTRACT

Described herein is an Advertisement Campaign System Using Escalators and Moving Walkways, the advertising campaign system comprises of advertisements positioned on the balustrades, the moving stairs, the exit of the escalator and the exit of the moving walkway, between two or more escalators, between two or more moving walkways or any other part of the escalator or moving walkway.

The invention which is an Advertisement Campaign System Using Escalators and Moving Walkways is invented by Krishan Advaney, a citizen of India and a resident of the Czech Republic, and Martina Advaney, a citizen and resident of the Czech Republic.

### BACKGROUND OF THE INVENTION

There are at present, millions of escalators and moving walkways installed at airports, train stations, office buildings, shopping malls, other buildings and even in cities. Escalators are moving staircases, which is a conveyer transport device for carrying people between floors of a building and moving walkways are a moving conveyor mechanism that transports people across a horizontal or an inclined plane. Currently, the balustrades of the moving walkways and escalators are plain coloured, usually black, and the moving stairs of escalators are also usually grey or black. The present invention uses the balustrades of the escalators and moving walkways, the moving steps of escalators, the exits of escalators and moving walkways, the entry points of escalators and moving and moving walkways, the surface area between escalators, the surface area next to the balustrades and the surface area between moving walkways, for the advertisement campaign system.

### BRIEF SUMMARY OF THE INVENTION

Briefly described the present invention comprises of advertisements positioned on the balustrades of escalators and moving walkways, on the moving steps of escalators, at the exits of escalators and moving walkways, at the entry points of escalators and moving walkways, the surface area next to the balustrades, the surface area between escalators and the surface area between moving walkways.

Another aspect of the present invention is directed to advertisements that are printed, painted, pasted, transferred, built, reflected, on the balustrades of escalators and moving walkways, on the moving steps of escalators, on a board fixed or placed independently at the exits of escalators and moving walkways, on a board fixed or placed independently at the entry points of escalators and moving walkways and on the surface of the space between escalators and the surface area between moving walkways, with or without a protective covering. The method of putting advertisements is not limited to printed, painted, pasted, reflected, built and transferred, but can use various other means within the scope and spirit of this invention.

Yet another aspect of the present invention is that the advertisements are electrically or electronically illuminated or non illuminated.

Yet another aspect of the present invention is that the advertisements are either static or non static.

Yet another aspect of the present invention is that multiple advertisements are fixed along the length of the escalators and moving walkways.

### BRIEF DESCRIPTION OF THE DRAWINGS

Reference is made to the attached drawings,

FIG. 1 is an example of an escalator showing advertisements, marked by the word ADVERTISEMENT, on the balustrade in accordance with the present invention,

FIG. 2 is an example of the balustrade of an escalator with advertisements, marked by the word ADVERTISEMENT, in accordance with the present invention.

FIG. 3 is an example of advertisements, marked by the word ADVERTISEMENT, on the balustrade of a moving walkway in accordance with the present invention.

FIG. 4 is an example of the balustrade of a moving walkway with advertisements, marked by the word ADVERTISEMENT, in accordance with the present invention.

FIG. 5 is an example of advertisements, marked by the word ADVERTISEMENT, on moving steps of an escalator in accordance with the present invention.

FIG. 6 is an example of an advertisement, marked by the word ADVERTISEMENT, fixed at the exit of an escalator in accordance with the present invention.

FIG. 7 is an example of an advertisement, marked by the word ADVERTISEMENT, fixed at the exit of a moving walkway in accordance with the present invention.

FIG. 8 is an example of an advertisement, marked by the word ADVERTISEMENT, placed at the exit of an escalator in accordance with the present invention.

FIG. 9 is an example of an advertisement, marked by the word ADVERTISEMENT, placed at the exit of a moving walkway in accordance with the present invention.

FIG. 10 is an example of advertisements, marked by the word ADVERTISEMENT, positioned at the entry point of an escalator in accordance with the present invention.

FIG. 11 is an example of advertisements, marked by the word ADVERTISEMENT, positioned at the entry point of a moving walkway in accordance with the present invention.

FIG. 12 is an example of advertisements, marked by the word ADVERTISEMENT, set between escalators in accordance with the present invention.

FIG. 13 is an example of advertisements, marked by the word ADVERTISEMENT, set between moving walkways in accordance with the present invention.

FIG. 14 is an example of multiple advertisements, marked by the word ADVERTISEMENT, set along the length of the escalator.

FIG. 15 is an example of multiple advertisements, marked by the word ADVERTISEMENT set along the length of the moving walkway.

### DETAILED DESCRIPTION OF THE INVENTION

The present invention is an advertisement campaign system using escalators and moving walkways. Although there are millions of escalators and moving walkways installed across the world which are used by millions of people worldwide on an everyday basis, most of these escalators and moving walkways have a black look. The present invention not only addresses the dullness of the look but importantly, provides an effective method of creating an advertisement campaign system in which the advertisements carried on the escalators and moving walkways can be viewed by millions of people on an everyday basis. Additionally, since many users of escalators and walkways have the tendency to be looking away, engage in conversations, being inattentive while on the escalators and walkways, the attention towards the advertisements would also bring into focus when the user is reaching close to the last steps of the escalator or end of the moving walkway, thus adding to the safety of the users of escalators and walkways.

The advertisements are printed, painted, pasted, transferred, reflected, built, on the balustrades of escalators and moving walkways, on the moving steps of escalators, on a board fixed or placed independently at the exit of escalators and moving walkways, on a board fixed or placed independently at the entry of the escalators and moving walkways, on the surface area next to the balustrades of escalators and moving walkways, on the surface of the space between escalators and the surface area between moving walkways, with or without a protective covering. The advertisements can also be illuminated and non illuminated. The advertisements can be static or non static. Multiple advertisements can be set along the length of the escalators and moving walkways, The method of putting advertisements is not limited to these but can use various other means within the scope and spirit of this invention.

There are several processes by which advertisements can be positioned on various parts of the escalators and moving walkways. One such process can be described as the transfer printing process in which the advertisements can be positioned on any part of the escalator or the moving walkway by transferring a coating of ribbon so that it adheres to the escalator or moving walkway. This can be in a single colour or it can be multicoloured. To use the transfer process to print onto an object, the design is printed onto the transfer material, this is then, using a pressure process or heat process or both, transferred on to an object which in this case is any part of the escalator or the moving walkway.

For illuminated advertisements there are several options. One such option is being described herein. A typical digital signage network includes 1. A remotely located central server, 2. Display panels installed at various host locations on the escalators and moving walkways. 3. A networked media player installed near the display and 4. a means to communicate with the player which can be wireless or cellular for example. The player receives the content from the central server over the internet and plays the contents on one or more display panels located on the escalators and moving walkways,

Reference will now be made in detail to the preferred embodiments of the invention, examples of which are illustrated in the accompanying drawings. While the invention will be described in conjunction with the preferred embodiments, it will be understood that they are not intended to limit the invention to those embodiments. On the contrary, the invention is intended to cover alternatives, modifications and equivalents which may be included within the spirit and scope of the invention as defined by the appended claims.

While the example embodiments in the present disclosure have been described in connection with what is presently considered to be the best mode for carrying out the subject matter specified in the appended claims, it is also to be understood that the example embodiments are only illustrative, and are not to restrict the subject matter speck fled in the appended claims.

The drawings are not drawn to scale, the emphasis instead being placed upon clearly illustrating the principles of the disclosure.

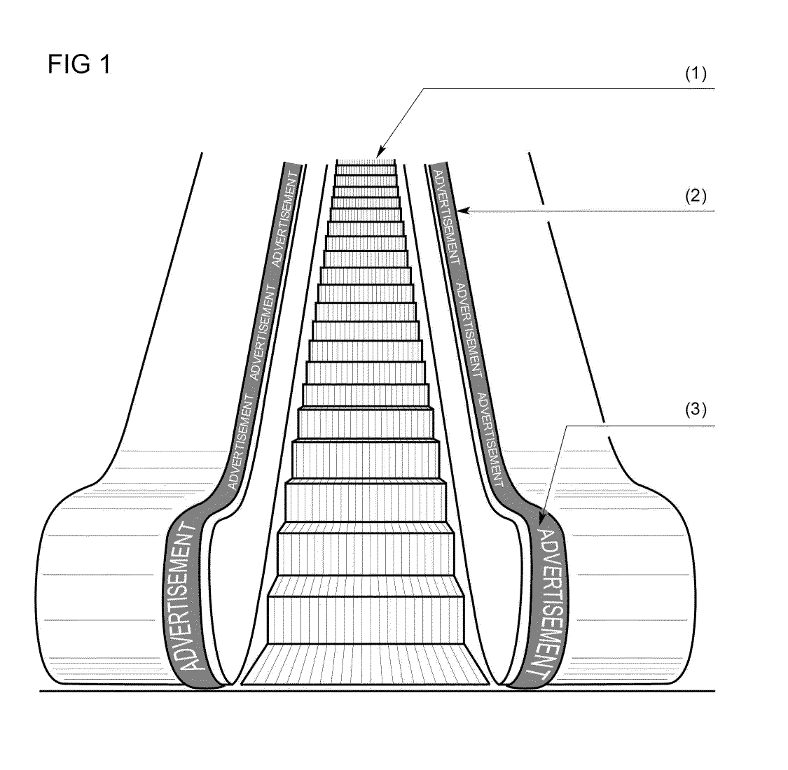

Referring to FIG. 1. an escalator with moving steps (1) and a moving balustrade (2) and areas of the balustrade showing potential advertisements (3), in accordance with the present invention.

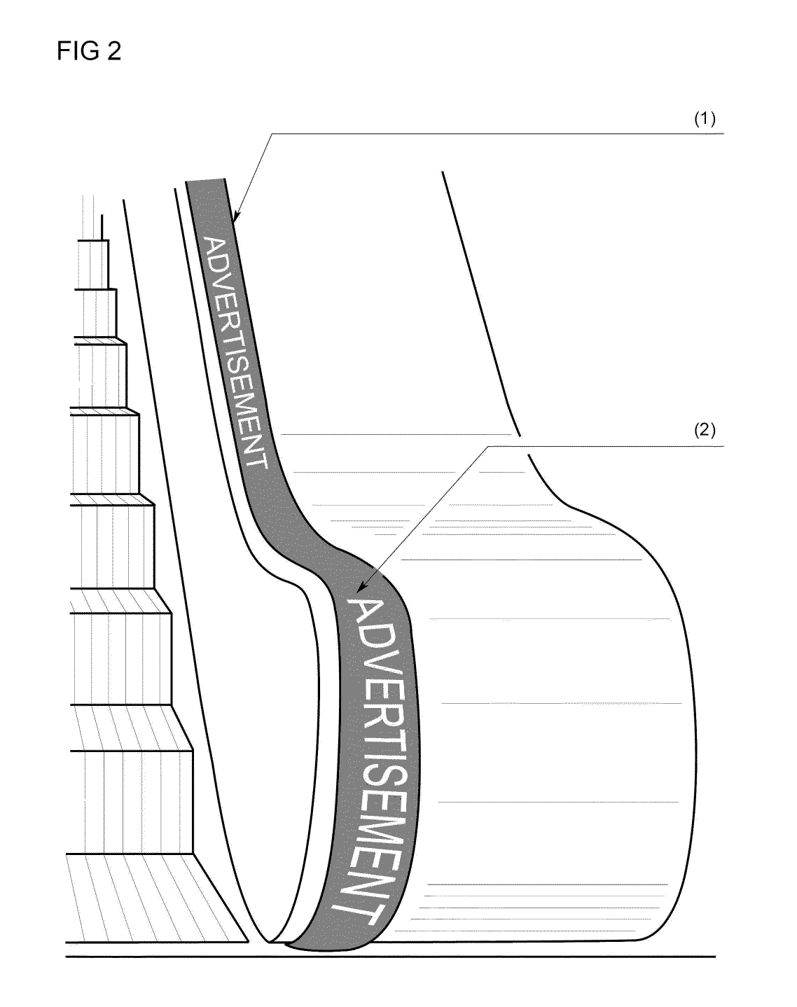

Referring to FIG. 2. a moving balustrade of the escalator (1) and areas of the balustrade showing potential advertisements (2), in accordance with the present invention.

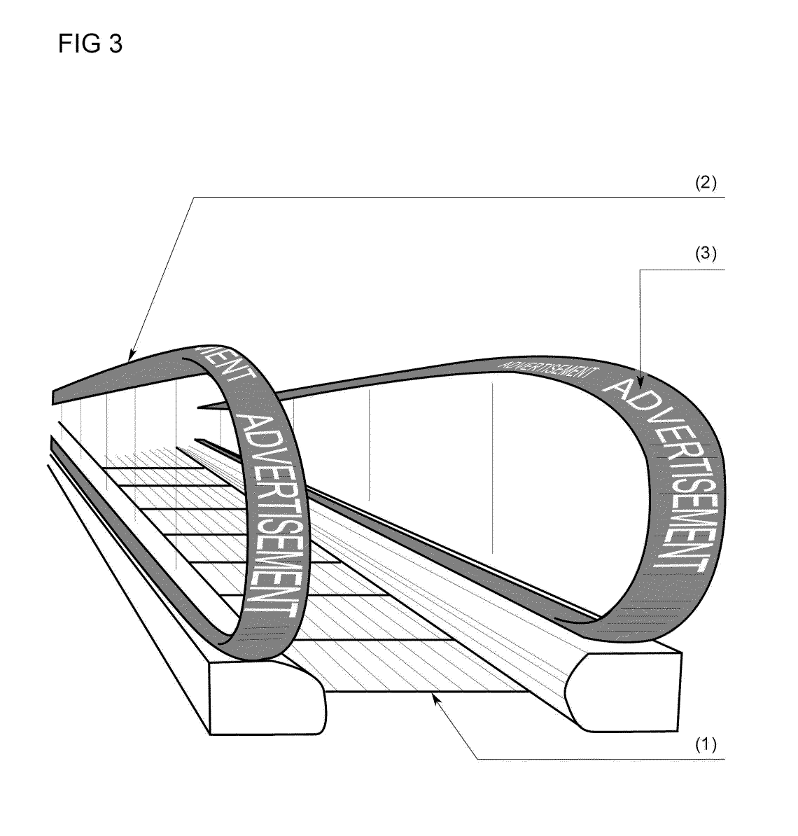

Referring to FIG. 3. a moving walkway (1) and a moving balustrade (2) and areas of the balustrade showing potential advertisements (3) in accordance with the present invention.

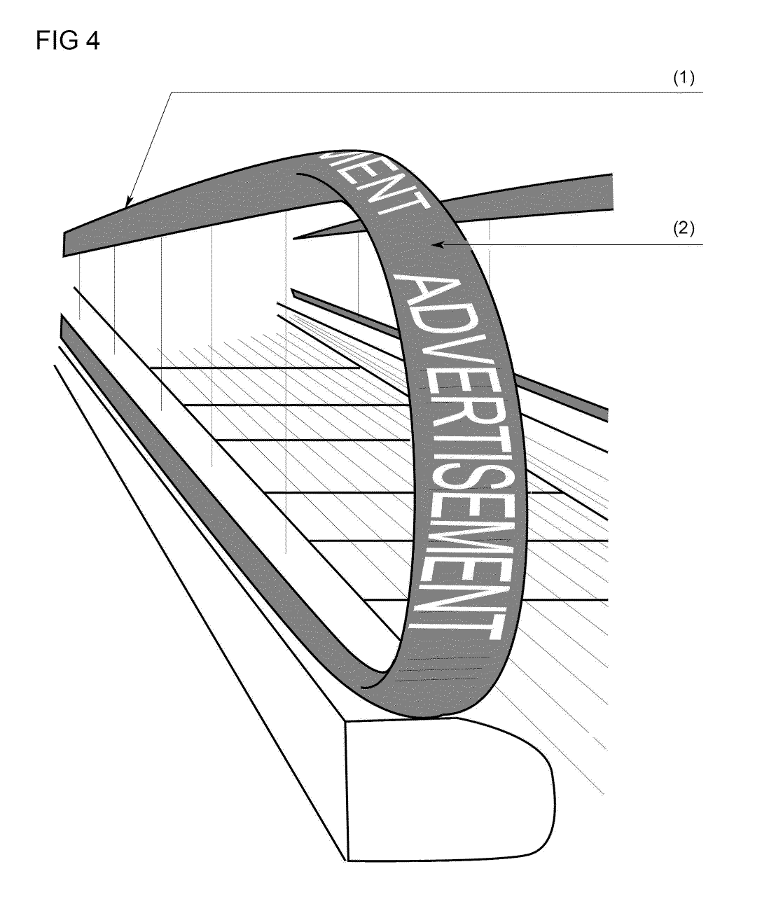

Referring to FIG. 4. a moving balustrade (1) of the moving walkway and areas on the moving balustrade showing potential advertisements (2) in accordance with the present invention.

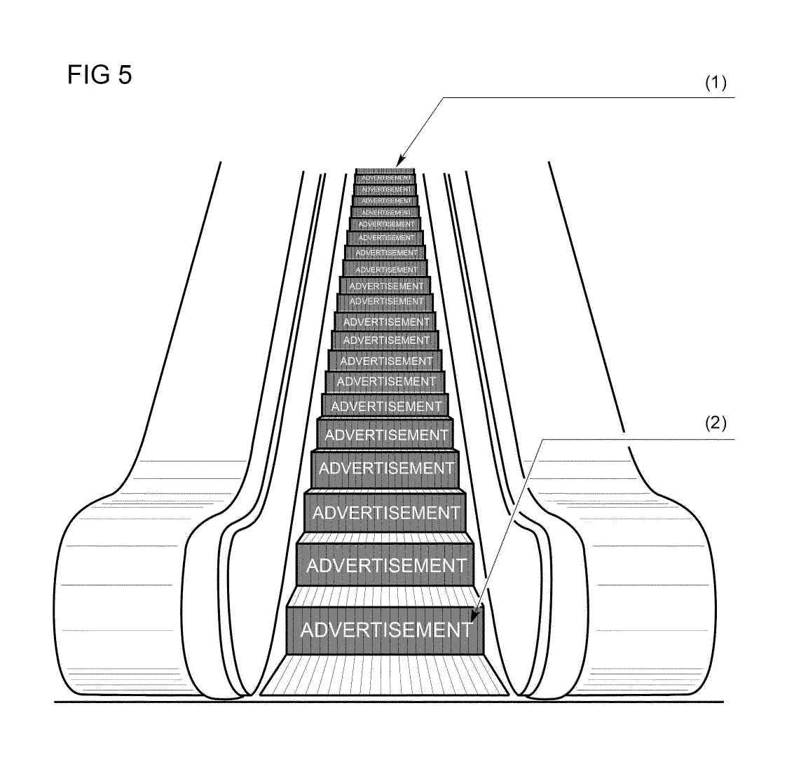

Referring to FIG. 5. moving steps of the escalator (1) and areas of he potential advertisements (2) in accordance with the present invention.

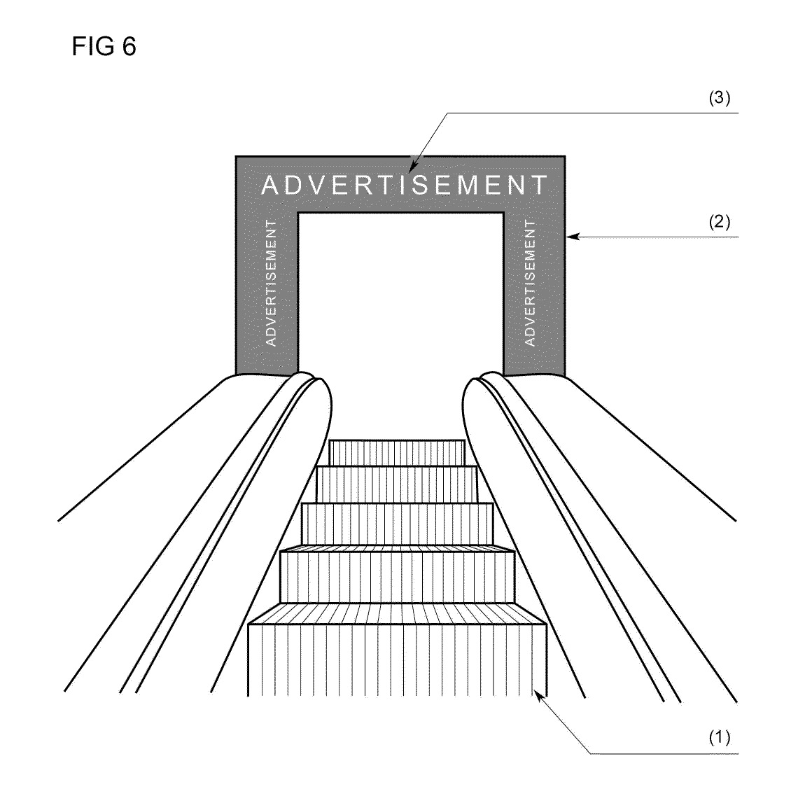

Referring to FIG. 6, an escalator (1) with an apparatus configured of a stand with a display board or illuminated system fixed to the exit of the escalator (2) and the area of the potential advertisements (3) in accordance with the present invention.

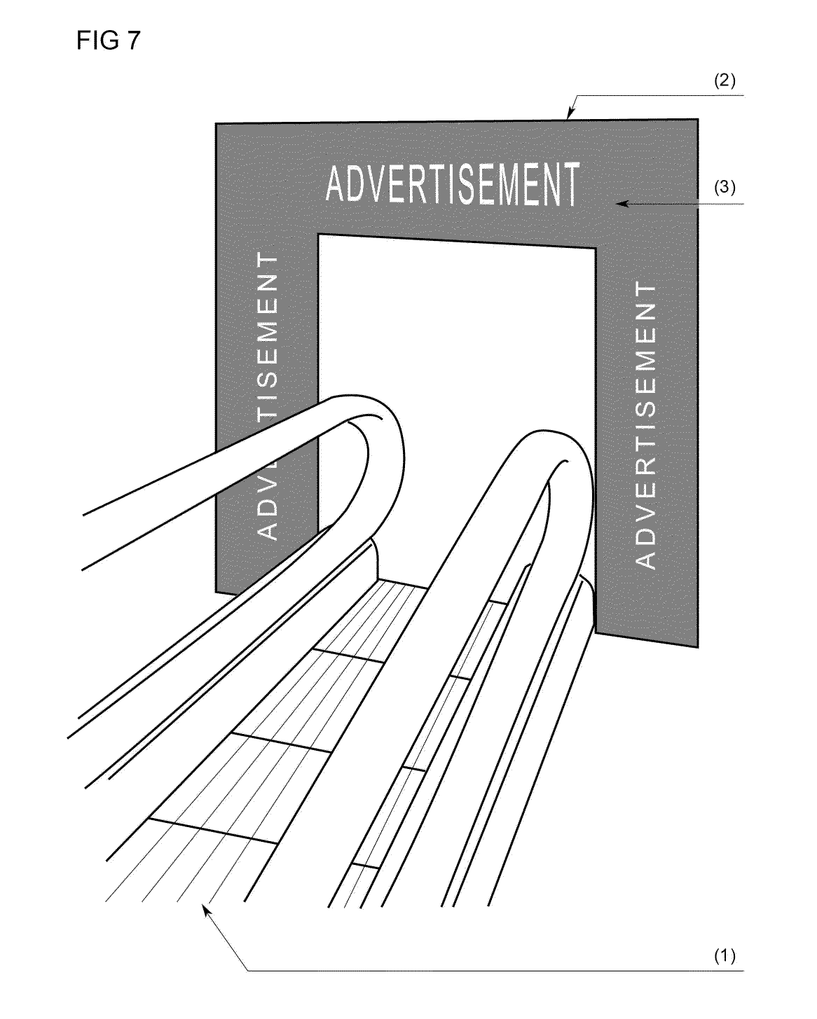

Referring to FIG. 7. a moving walkway (1) with an apparatus configured of a stand and a display board or illuminated system fixed to the exit of the moving walkway (2) and the area of the potential advertisements (3) in accordance with the present inventing.

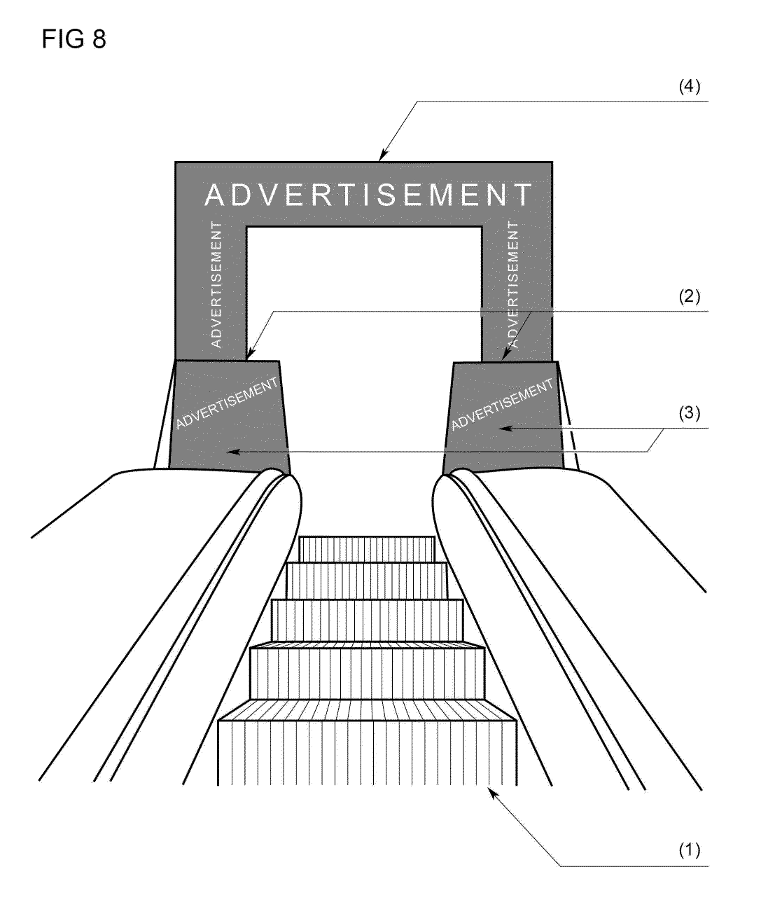

Referring to FIG. 8, an escalator (1) with an apparatus configured of a stand and a board or an illuminated display system kept dose the exit of the escalator (2) and the area of the potential advertisements (3) and another example of the apparatus for the advertisement (4) in accordance with the present invention.

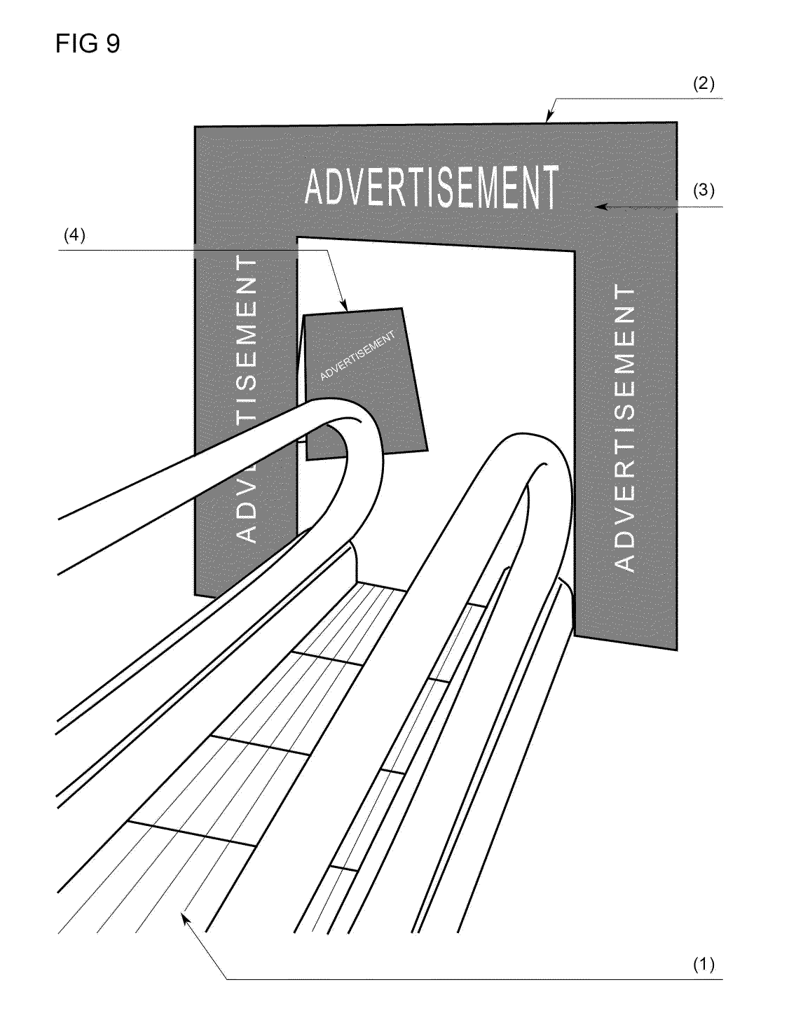

Referring to FIG. 9. a moving walkway (1) with an apparatus configured of a stand and a board or an illuminated display system kept at the exit of the moving walkway (2) and the area of the potential advertisements (3) and another example of the apparatus for the advertisements (4) in accordance with the present invention.

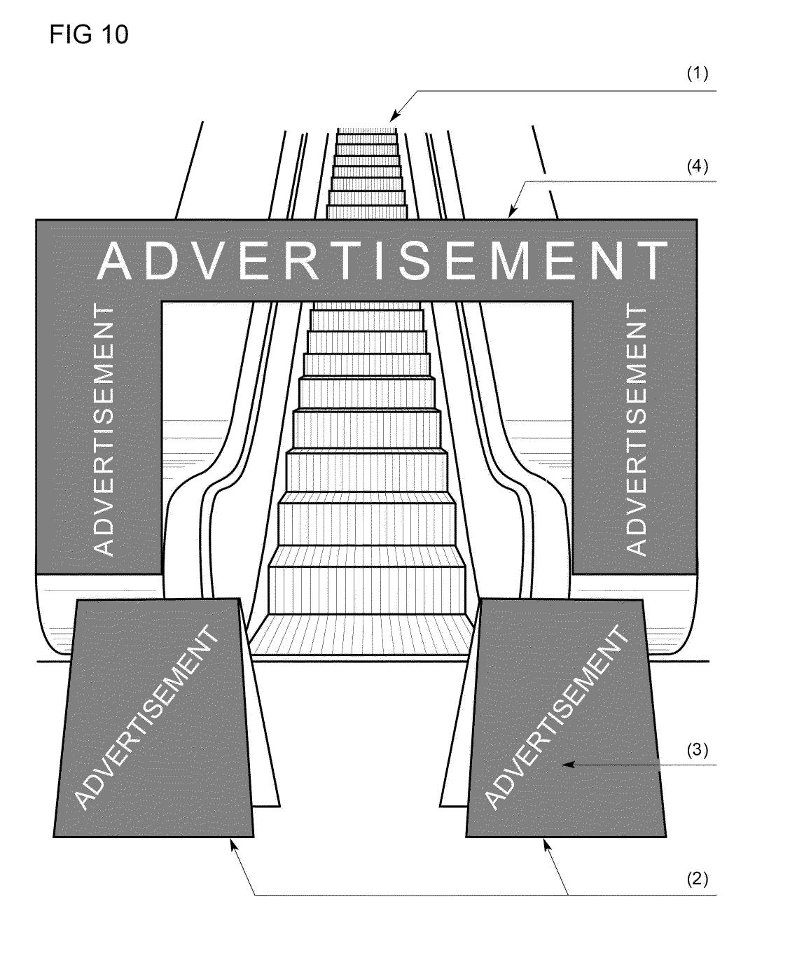

Referring to FIG. 10, an escalator (1) with an apparatus configured of a stand and a board or an illuminated display system positioned at or dose to the entry point of the escalator (2) and the area of the potential advertisements (3) and another example of the apparatus for the advertisement (4) in accordance with the present invention,

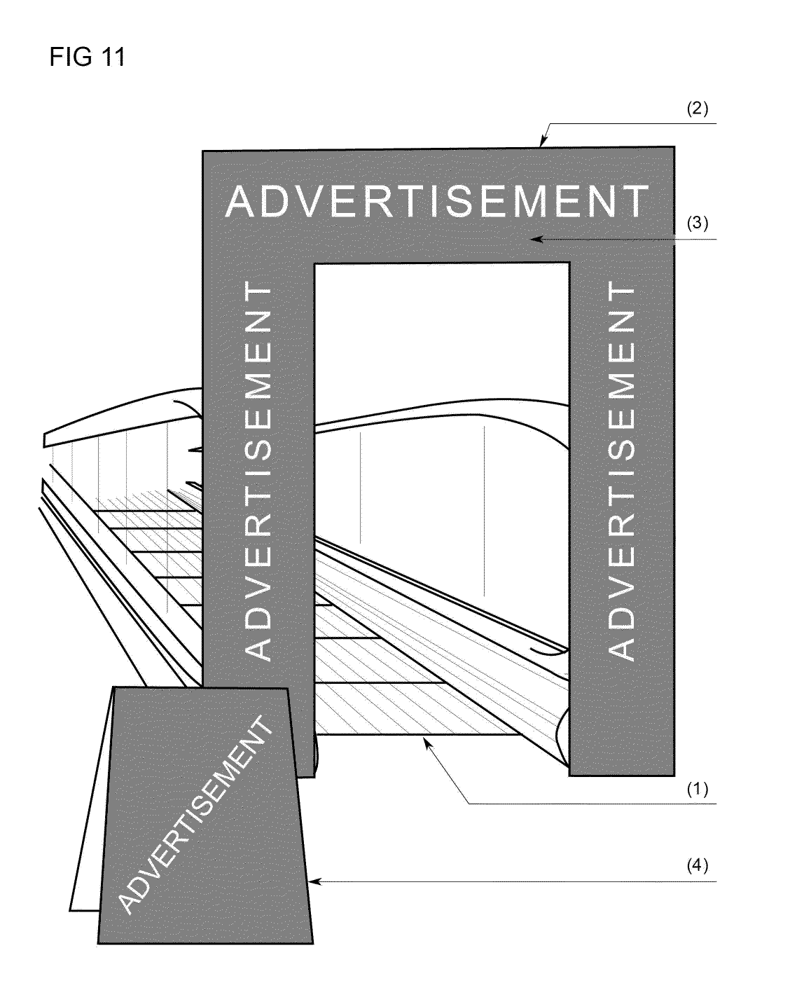

Referring to FIG. 11, a moving walkway (1) with an apparatus configured of a stand and a board or an illuminated display system positioned at or dose to the entry point of the moving walkway (2) and the area of the potential advertisements (3) and another example of the apparatus for the advertisement (4) in accordance with the present invention.

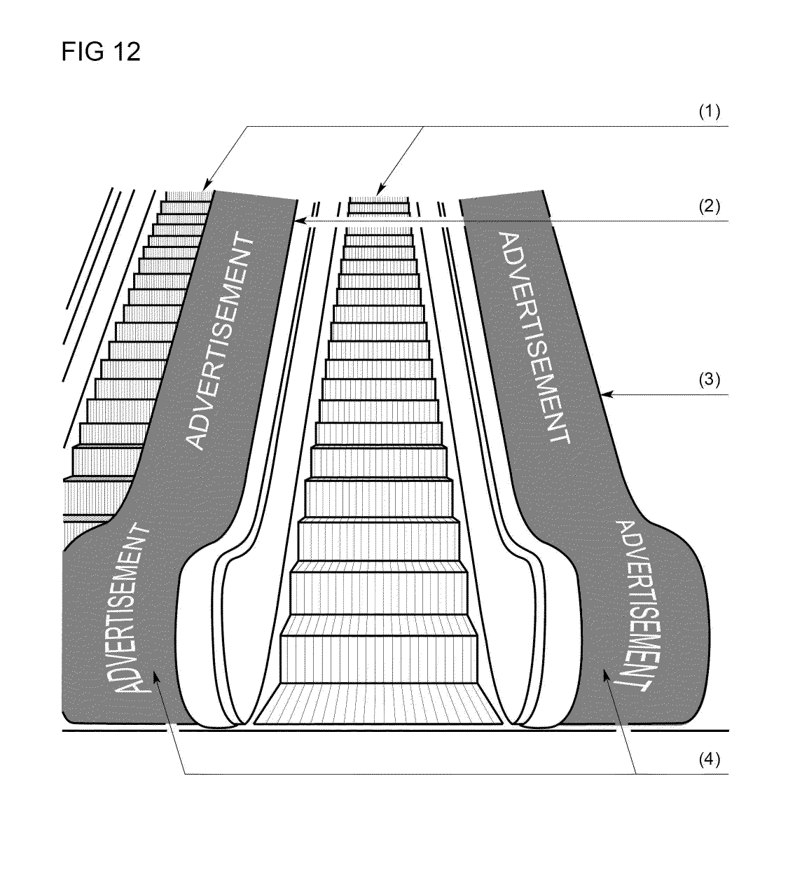

Referring to FIG. 12. two escalators (1), the area between two escalators (2), the area dose to the balustrade (3) and the potential advertisements (4) in accordance with the present invention.

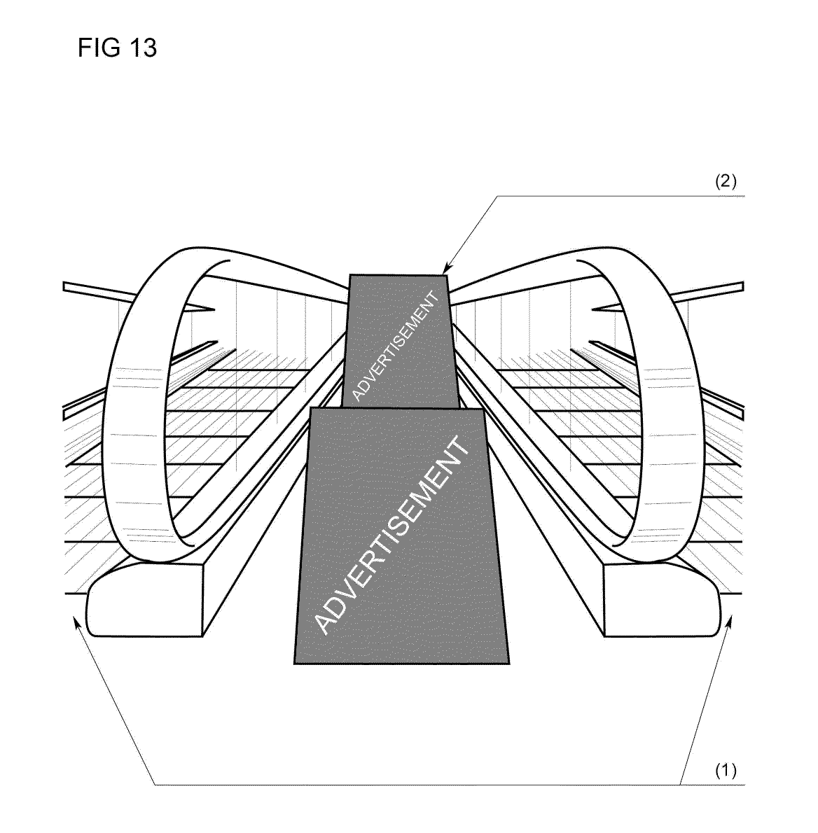

Referring to FIG. 13, two moving walkways (1), the area between two moving walkways (2) and the potential advertisements in accordance with the present invention.

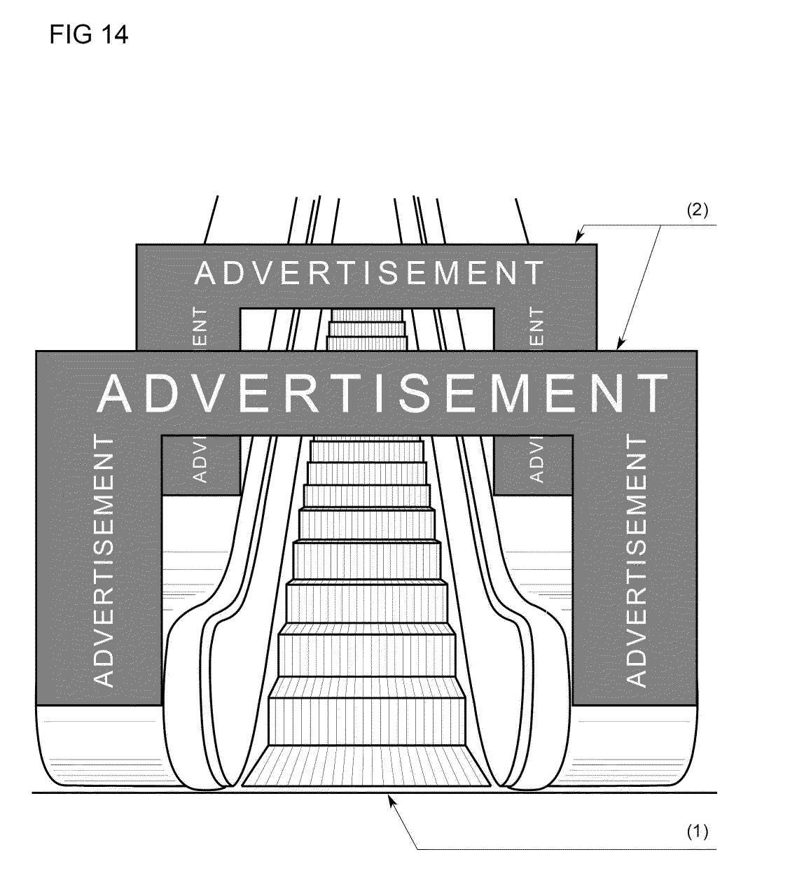

Referring to FIG. 14, an escalator or (1), multiple advertisements set along the length of the escalator (2) in accordance with the present invention.

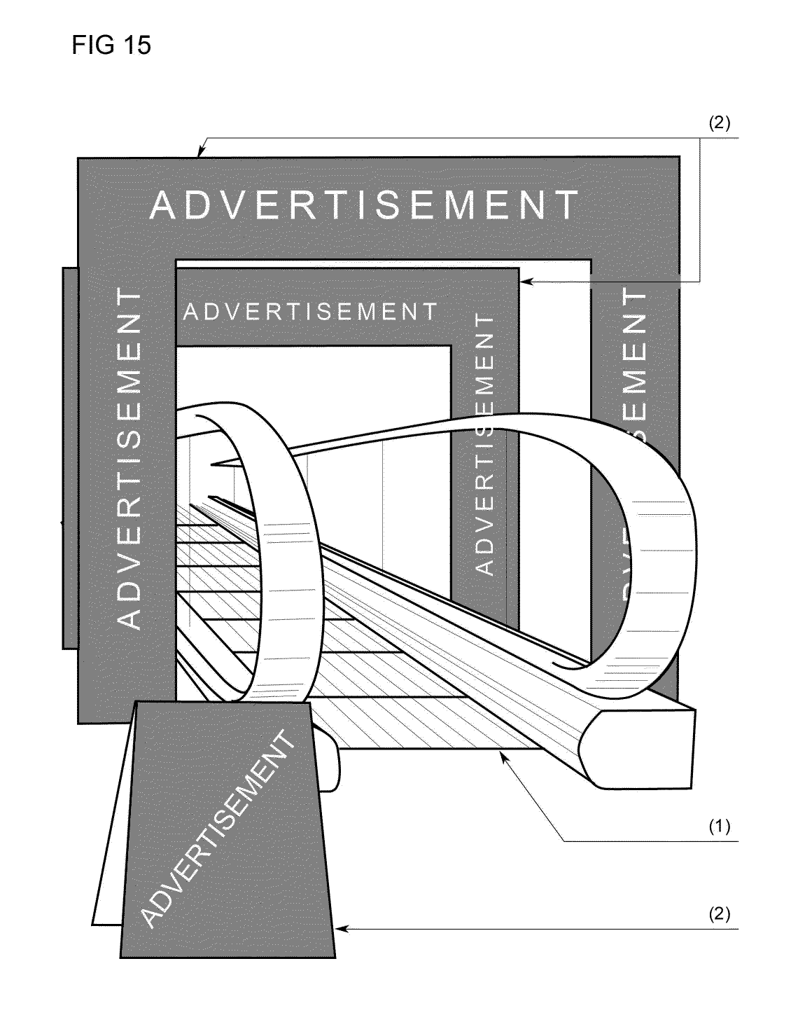

Referring to FIG. 15, a moving walkway (1), multiple advertisements set along the length of the moving walkway (2) in accordance with the present invention.

1. A method comprising of advertisement campaign system using escalators and moving walkways, the said method comprising of advertisements positioned on different parts of the escalators and moving walkways.

2. The method of claim 1 wherein the advertisements are positioned on the balustrades of escalators.

3. The method of claim 1 wherein the advertisements are positioned on the balustrades of moving walkways.

4. The method of claim 1 wherein the advertisements are positioned at the exits of escalators.

5. The method of claim 1 wherein the advertisements are positioned at the exits of moving walkways.

6. The method of claim 1 wherein the advertisements are positioned close to the exit of escalators.

7. The method of claim 1 wherein the advertisements are positioned close to the exit of moving walkways.

8. The method of claim 1 wherein the advertisements are positioned at the entry point of escalators.

9. The method of claim 1 wherein the advertisements are positioned at the entry point of moving walkways.

10. The method of claim 1 wherein the advertisements are positioned close to the entry point of escalators.

11. The method of claim 1 wherein the advertisements are positioned close to the entry point of moving walkways.

12. The method of claim 1 wherein the advertisements are positioned between the surface area of the space between two or more escalators.

13. The method of claim 1 wherein the advertisements are positioned between the surface area of the space between two or more moving walkways.

14. The method of claim 1 wherein the advertisements are positioned on the moving stairs of escalators.

15. The method of claim 1 wherein the advertisements are positioned on the surface area close to the balustrade of the escalator

16. The method of claim 1 wherein the advertisements are positioned on the surface area close to the balustrade of the moving walkway.

17. The method of claim 1 wherein the advertisements are positioned at any other part of escalators and moving walkways.

18. The method of claim 1 wherein the advertisements are positioned after the installation of escalators.

19. The method of claim 1 wherein the advertisements are positioned after the installation of moving walkways.

20. The method of claim 1 wherein the advertisements are positioned in the currently installed escalators.

21. The method of claim 1 wherein the advertisements are positioned in the currently installed moving walkways.

22. The method of claim 1 wherein the display system for advertisements is built into any part of the escalators, including the balustrades and steps, during the manufacturing process.

23. The method of claim 1 wherein the display system for advertisements is built into any part of the moving walkways, including the balustrades, during the manufacturing process.

24. The method of claim 1 wherein the advertisements are positioned on any part of the escalators, including the balustrades and steps during the manufacturing process.

25. The method of claim 1 wherein the advertisements are positioned on any part of the moving walkways, including the balustrades during the manufacturing process.

26. The method of claim 1 wherein multiple advertisements are positioned along the length of the escalator.

27. The method of claim 1 wherein multiple advertisements are positioned along the length of the moving walkway.

28. The method of claim 1 which has the option to have audio or visual warnings or both so that users should not mss a step.

29. The method of claim 1 which has the option to have plurality of advertisers.
